(19) United States
(12) Patent Application Publication
(10) Pub. No.: US 2009/0120587 A1
(43) Pub. Date: May 14, 2009

(54) SHEET STICKING TABLE

(75) Inventors: Tsuyoshi Kurita, Tokyo (JP); Koichi Yamaguchi, Tokyo (JP); Kenji Kobayashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Itabashi-ku, Tokyo (JP)

(21) Appl. No.: 11/994,950

(22) PCT Filed: Jun. 26, 2006
(86) PCT No.: PCT/JP2006/312687

§ 371 Date: Jan. 7, 2008

(30) Foreign Application Priority Data
Jul. 7, 2005 (JP) 2005-198808
Jan. 25, 2006 (JP) 2006-015782

(51) Int. Cl. B32B 38/04; B29C 65/56

(52) U.S. Cl. 156/523; 156/582

(57) ABSTRACT

A sheet sticking table 13 used for sticking an adhesive sheet S onto the upper surface of a semiconductor wafer W is provided. The sheet sticking table 13 comprises an outer table 51 and an inner table 52. The outer table 51 and inner table 52 are provided movably in the vertical direction via uniaxial robots 54, 56 respectively, and the inner table 52 is provided movably together with the outer table 51 in the vertical direction when the outer table 51 is moved in the vertical direction.

### FIELD OF THE INVENTION

The present invention relates to a sheet sticking table, particularly to a sheet sticking table capable of adjusting the level position according to the thicknesses of a plate-like object and a sheet to be stuck thereon.

### BACKGROUND OF THE ART

Conventionally, semiconductor wafers (hereinafter, simply referred to as “wafer”) are stuck with a protective sheet for protecting circuit surface thereof, and stuck with an adhesive sheet for die bonding on the rear surface thereof.

As a table used for sticking the sheet to the wafer as described above, for example, a table disclosed in patent document 1 is known. The table is provided movably in the vertical direction to adjust the upper surface position of the wafer disposed on the table so as to come into line with the upper surface position of an outer frame, which is disposed in the peripheral area of the table.

Patent document 1: Japanese Patent Application Laid-Open No. 2004-47976

### SUMMARY OF THE INVENTION

### Problem to be Solved by the Invention

The table disclosed in the patent document 1 is provided with only such an arrangement to allow a movement in the vertical direction to adjust the upper surface position of the wafer disposed on the table so as to come into line with the upper surface of the outer frame. The table is not arranged to adjust the level thereof according to the alteration of sheet thickness. That is, the table disclosed in the patent document 1 has merely such an arrangement that a press roller moves rolling while contacting with the outer frame of the table without abutting against the upper surface of the table, in order to prevent the elongation or the like of the sheet, which is caused by the press roller when it moves up to the upper surface of the wafer from the upper surface of the table by the thickness of the wafer.

Generally, the positional relationship between the press roller and the table is to obtain a relative level therebetween so that an appropriate press force can be imparted with respect to the thickness of the sheet. Therefore, when the sheet thickness is modified to the increased one, an excessive press force may be imparted, leading to a crack of the wafer, and the like. Accordingly, a change of the positional relationship between the press roller and the table becomes an essential requirement.

However, in the arrangement disclosed in the patent document 1, when the level of the table is lowered, the upper surface position of the wafer becomes relatively lower with respect to the upper surface position of the outer frame. As a result, due to a difference in the level position with respect to the outer frame, there arises such disadvantage as shortage of the press force or an unintended elongation of the sheet.

### Object of the Invention

The present invention has been proposed in view of the above disadvantages. An object of the present invention is to provide a sheet sticking table capable of adjusting level position according to the thicknesses of the sheet and/or the wafer.

### Means for Solving Problems

In order to achieve the object, the present invention adopts such an arrangement that a sheet sticking table to stick a sheet onto an upper surface of a plate-like object through pressing by a press roller, the sheet being fed out from a sheet feed-out unit, comprising: an inner table for supporting the plate-like object; and an outer table disposed to surround the inner table, wherein the inner table moves in the vertical direction corresponding to the thickness of the plate-like object with the upper surface of the outer table as a reference position, and the press roller is provided movably in the vertical direction corresponding to the thickness of the sheet with the upper surface of the outer table as a reference.

Also, the present invention may adopt such an arrangement that a sheet sticking table for sticking a sheet onto an upper surface of a plate-like object through pressing by a press roller, the sheet being fed out from a sheet feed-out unit, comprises: an inner table for supporting the plate-like object; and an outer table disposed to surround the inner table, wherein the outer table moves in the vertical direction corresponding to the thickness of the plate-like object with the upper surface of the inner table as a reference position, the press roller is provided movably in the vertical direction corresponding to the thickness of the sheet with the upper surface of the outer table as a reference.

Further, the present invention may adopt such an arrangement that a sheet sticking table for sticking a sheet onto an upper surface of a plate-like object through pressing by a press roller, the sheet being fed out from a sheet feed-out unit, comprises: an inner table for supporting the plate-like object; and an outer table disposed to surround the inner table, wherein the inner table and the outer table are provided movably in the vertical direction respectively.

The present invention preferably adopts such an arrangement that the inner table is provided movably in the vertical direction together with the outer table when the outer table is moved in the vertical direction.

Further, the inner table moves in the vertical direction corresponding to the thickness of the plate-like object with the upper surface of the outer table as a reference position, the outer table moves in the vertical direction corresponding to the thickness of the sheet with the press surface of the press roller as a reference, whereby the press force of the press roller is maintained at a constant level.

Furthermore, a gap for cutting the sheet stuck on the plate-like object along the outer edge of the plate-like object is formed between the inner table and the outer table.

Still further, the plane shape of the inner table is substantially identical to the plane shape of the plate-like object.

### EFFECT OF THE INVENTION

According to the present invention, since the inner table and the outer table are capable of moving in the vertical direction, even when the thicknesses of the plate-like object and the sheet are altered, the inner table and the outer table can be adjusted to obtain the optimum sticking conditions corresponding to such alteration. Also, when only the thickness of the plate-like object is altered, only the inner table is adjusted without adjustment of the outer table.

Also, since the inner table is movable in the vertical direction together with the outer table, when only the thickness of the sheet is altered, by adjusting the level of the outer table only, the level of the inner table also can be set to an optimum level position.

### BRIEF DESCRIPTION OF THE DRAWINGS

FIG. 1 is a front view schematically showing a sheet sticking apparatus in accordance with the embodiment.

FIG. 2 is a perspective view schematically showing the sheet sticking apparatus.

FIG. 3 is a cross sectional view schematically showing a sheet sticking table.

FIGS. 4(A) to 4(E) are explanatory views showing sticking operation of the adhesive sheet.

FIGS. 5(A) to 5(D) are explanatory views showing peeling operation of unnecessary adhesive sheet by a peeling apparatus.

### EXPLANATION OF REFERENCE NUMERALS

10: sheet sticking apparatus
12: sheet feed-out unit
13: sheet sticking table
14: press roller
51: outer table
52: inner table
C: gap
PS: release liner
S: adhesive sheet
W: wafer (plate-like object)

### DESCRIPTION OF THE PREFERRED EMBODIMENTS

Hereinafter, embodiments of the invention will be described with reference to the drawings.

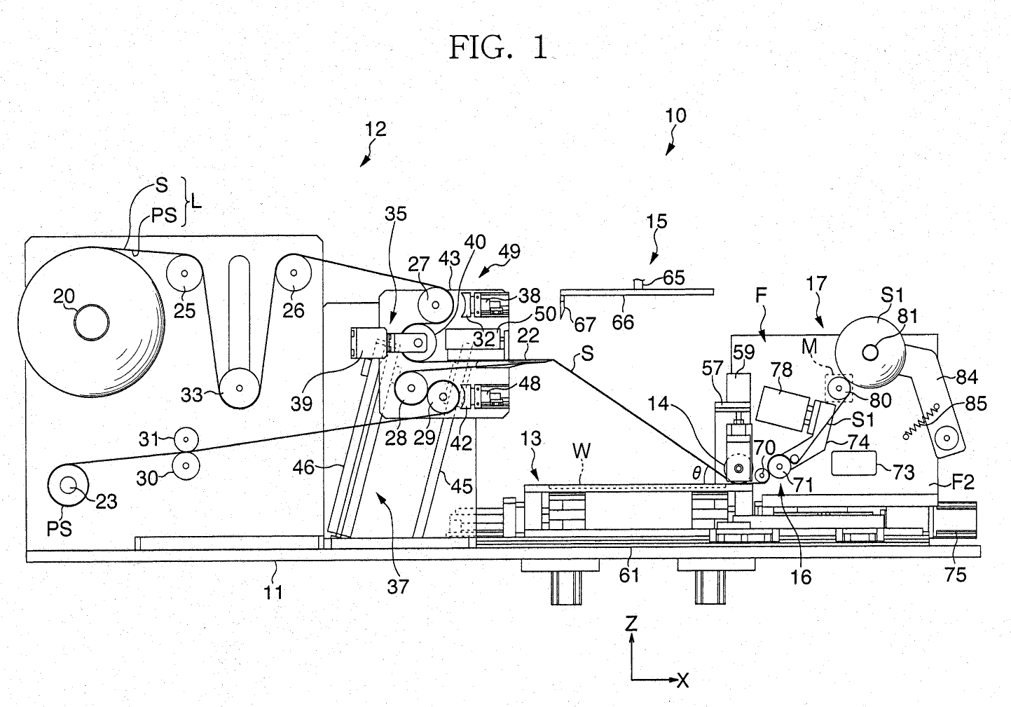

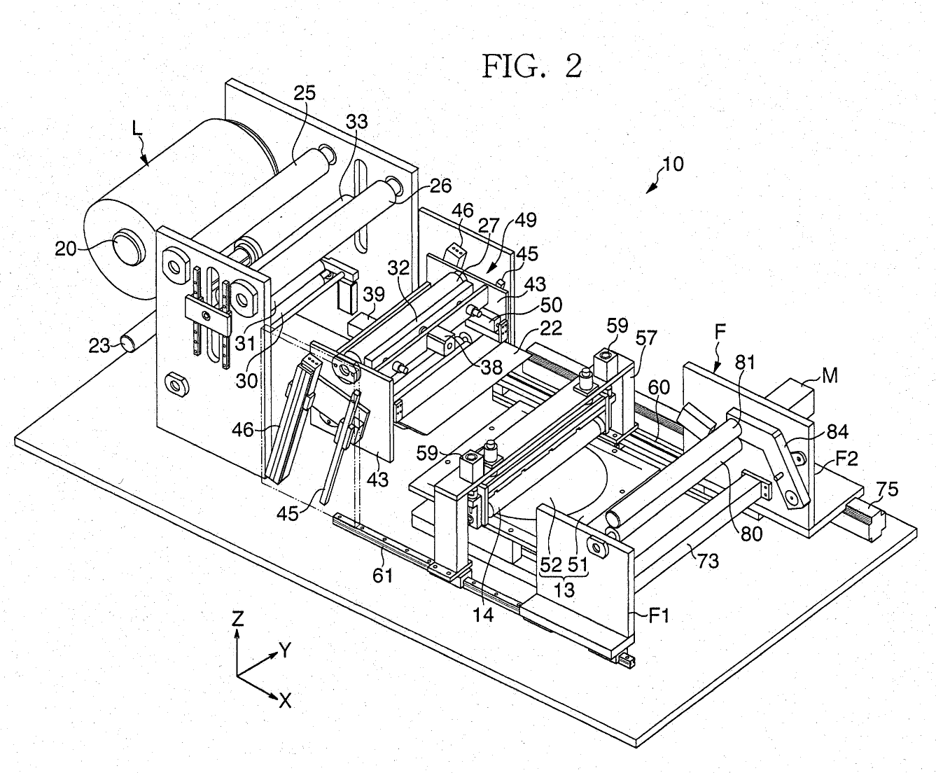

FIG. 1 is a front view schematically showing a sheet sticking apparatus according to the embodiment; and FIG. 2 is a schematic perspective view thereof. In these figures, a sheet sticking apparatus 10 comprises: a sheet feed-out unit 12 disposed in the upper portion of a base 11; a sheet sticking table 13 for supporting a wafer W as a plate-like object; a press roller 14 for imparting a press force to an adhesive sheet S fed out to the upper surface side of the wafer W to stick the adhesive sheet S to the wafer W; a cutter 15 for cutting the adhesive sheet S along the outer periphery of the wafer W after sticking the adhesive sheet S to the wafer W; a peeling apparatus 16 for peeling off unnecessary adhesive sheet S1 outside the wafer W from the upper surface of the sheet sticking table 13; and a winding apparatus 17 for winding the unnecessary adhesive sheet S1.

The sheet feed-out unit 12 comprises: a support roller 20 for supporting a rolled raw strip sheet L in which the strip of adhesive sheet S is temporarily stuck on one surface of a strip of a release liner PS; a peel plate 22 with which the raw strip sheet L fed out from the support roller 20 is sharply folded back to peel off the adhesive sheet S from the release liner PS; a collection roller 23 for collecting the release liner PS by winding the same; a plurality of guide rollers 25 to 31 disposed between the support roller 20 and the collection roller 23; a buffer roller 33 disposed between the guide rollers 25 and 26; a tension measuring means 35 disposed between the guide rollers 27 and 28; and a sticking-angle maintaining means 37 for integrally supporting the peel plate 22, guide rollers 27, 28, 29 and the tension measuring means 35. Note that the guide rollers 27 and 29 are concomitantly provided with brake shoes 32 and 42 respectively. These brake shoes 32 and 42 are arranged so as, when sticking the adhesive sheet S to the wafer W, to be moved toward/away from the corresponding guide rollers 27, 29 by means of cylinders 38, 48 respectively, to nip the adhesive sheet S to restrain the feeding thereof.

The tension measuring means 35 comprises a load cell 39 and a tension measuring roller 40 supported by the load cell 39 and located at the base side of the peel plate 22. The tension measuring roller 40 is pulled by a tension of the adhesive sheet S, which is nipped by the guide roller 27 and the brake shoe 32 and is fed out to the press roller 14, and the tension is transmitted to the load cell 39. And, there is such an arrangement that while the load cell 39 measures the tension of the adhesive sheet S fed out, a feed-out head 49, which will be described later, moves downward at an angle in FIG. 1 via the sticking-angle maintaining means 37 so that the tension of the adhesive sheet S is maintained at a constant level.

The sticking-angle maintaining means 37 is arranged to interact with the press roller 14 so as to maintain the sticking angle θ of the adhesive sheet S with respect to the wafer W at a constant angle. The sticking-angle maintaining means 37 comprises: a feed-out head 49 including guide rollers 27, 28 and 29, the load cell 39, the tension measuring roller 40, brake shoes 32 and 42, cylinders 38 and 48, the peel plate 22 and a pair of slide plates 43 and 43 for supporting above items; a pair of guide rails 45, 45 for vertically guiding the feed-out head 49; and a pair of uniaxial robots 46 and 46 for imparting a force to the feed-out head 49 to move in the vertical direction. The guide rails 45 and the uniaxial robots 46 are disposed in an inclined posture enabling to move the feed-out head 49 vertically along the inclined angle. Note that the peel plate 22 is supported by a cylinder 50 disposed at the inner side of the slide plates 43 enabling to move forward and backward in the X-direction in FIG. 1. Owing to this, the front edge position of the peel plate 22 can be adjusted in accordance with the diameter of the wafer W.

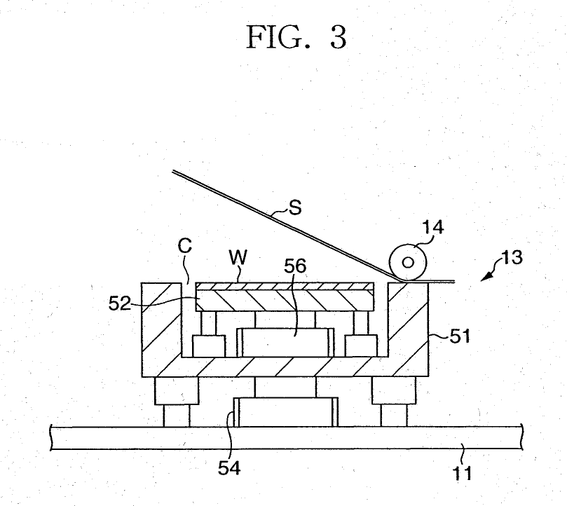

As shown in FIG. 3, the sheet sticking table 13 comprises: an outer table 51 having a substantially square shape in plane view; and an inner table 52 having a substantially circular shape in plane view. Between the outer table 51 and the inner table 52, a gap C is formed for cutting the adhesive sheet S along the periphery of the wafer with a cutter, which will be described later. The outer table 51 is configured with a concave-shape to receive the inner table 52, and is arranged so as to move in the vertical direction with respect to the base 11 via a uniaxial robot 54. On the other hand, the inner table 52 is arranged so as to move in the vertical direction with respect to the outer table 51 via a uniaxial robot 56. Accordingly, the outer table 51 and the inner table 52 are arranged so as to move integrally in the vertical direction as well as to move in the vertical direction independently each other. Owing to this, the outer table 51 and the inner table 52 are arranged to be adjustable to a predetermined level position corresponding to the thicknesses of the adhesive sheet S and the wafer W. Note that the inner table 52 is formed in a shape substantially identical to the plane shape of the wafer W.

The press roller 14 is supported via a portal frame 57. On the upper face side of the portal frame 57, cylinders 59, 59 are provided. The press roller 14 is arranged so as to move in the vertical direction owing to the operation of these cylinders 59 according to the thickness of the adhesive sheet S. As shown in FIG. 2, the portal frame 57 is arranged to be movable in the X-direction in FIG. 1 via the uniaxial robot 60 and the guide rail 61. Here, the cylinder 59 employs a uniaxial robot cylinder driven by a motor of which movement amount is controlled based on numerical information.

The cutter 15 is provided movably in the vertical direction via a lifter (not shown) above the sheet sticking table 13. The cutter 15 comprises: a rotation arm 66 fixed to a rotation center shaft 65, and a cutter blade 67 supported by the rotation arm 66. When the cutter blade 67 is rotated about the rotation center shaft 65, the adhesive sheet S can be cut along the outer periphery of the wafer W.

As shown in FIGS. 1, 4 and 5, the peeling apparatus 16 comprises a small diameter roller 70 and a large diameter roller 71. A moving frame F supports the small diameter roller 70 and the large diameter roller 71. The moving frame F comprises a front frame F1 and a rear frame F2, which are opposing to each other in the Y-direction in FIG. 2, the rear frame F2 being connected to the front frame F1 via a connecting member 73. The rear frame F2 is supported by a uniaxial robot 75, while the front frame F1 is supported by the guide rail 61. Owing to this, the moving frame F is movable in the X-direction in FIG. 2. An arm member 74 supports the large diameter roller 71 as shown in FIG. 1. The arm member 74 is arranged so that a cylinder 78 can move the large diameter roller 71 in the direction closer to/away from the small diameter roller 70.

The winding apparatus 17 comprises: a drive roller 80 supported by the moving frame F; and a winding roller 81, which is supported at the free-end of the rotation arm 84 being abutted on the circumferential surface of the drive roller 80 via a spring 85 to nip the unnecessary adhesive sheet S1. A drive motor M is disposed at the shaft end of the drive roller 80, and it is arranged so that, when the drive roller 80 is driven to rotate by the motor M, the winding roller 81 follows the drive roller 80 to rotate; thereby the unnecessary adhesive sheet S1 is wound thereon. Note that as the wound amount increases, the winding roller 81 shifts rightward in FIG. 1 against the force of the spring 85.

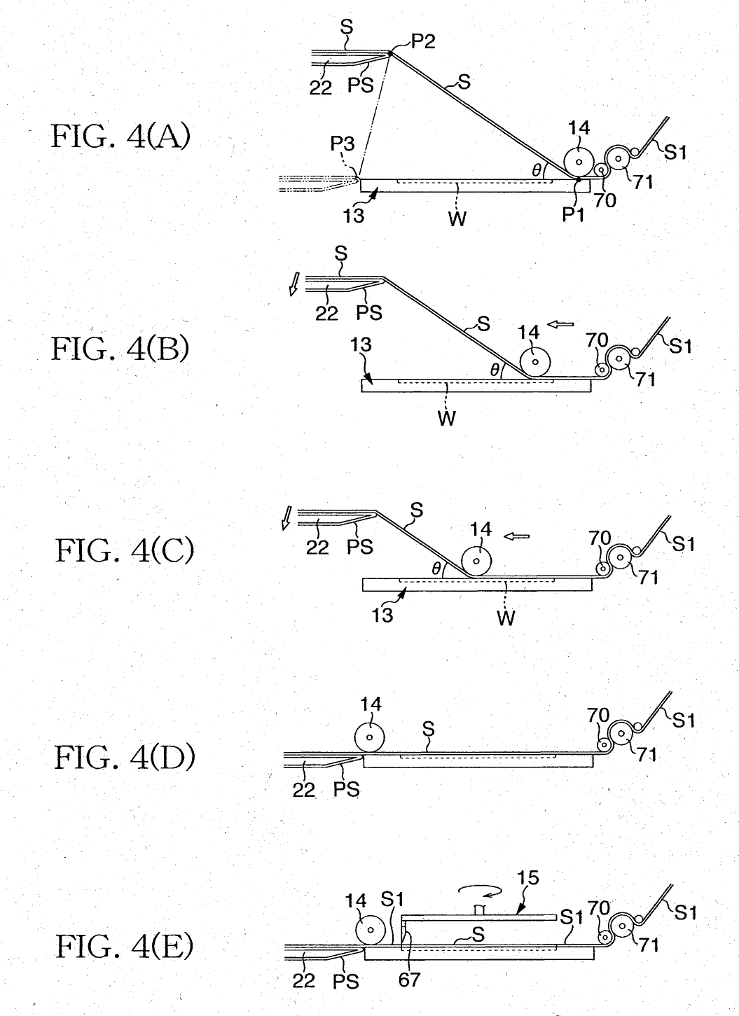

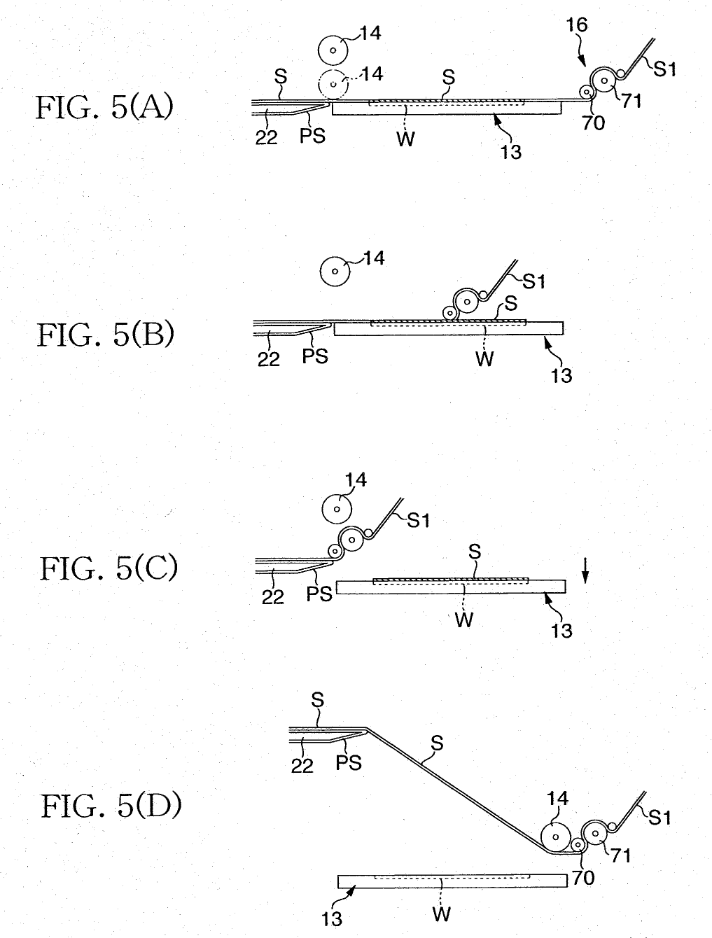

Next, the sticking method of the adhesive sheet S in accordance with the embodiment will be described with reference to FIGS. 4 and 5 as well.

In the initial setting, in the raw strip sheet L, which is fed out from the support roller 20, the adhesive sheet S is peeled off from the release liner PS at the front edge position of the peel plate 22, and the lead end of the release liner PS is fixed to the collection roller 23 through the guide rollers 28, 29. On the other hand, the lead end of the adhesive sheet S is fixed to the winding roller 81 of the winding apparatus 17 through the press roller 14 and the peeling apparatus 16. Here, the peel plate 22 constituting the front end of the feed-out head 49 is positioned at its upper limit position (refer to FIG. 1 and FIG. 4(A)). And the adhesive sheet S between the peel plate 22 and the press roller 14 is set so as to have a predetermined sticking angle θ with respect to the surface of the wafer W disposed on the sheet sticking table 13 as shown in FIG. 1. Also, the position of the front end of the peel plate 22 is adjusted by the cylinder 50 so that the length of the adhesive sheet S between the peel plate 22 and the press roller 14 is a little longer than the length from the one end to the other end, i.e., from the right end to the left end of the wafer W in FIG. 4.

The sheet sticking table 13 is adjusted in advance so that, in a state that the wafer W is supported by the inner table 52, the upper surface of the wafer W is set into line with the upper surface of the outer table 51. That is, the upper surface of the inner table 52 is set to be lower than the upper surface position of the outer table 51 by an amount equivalent to the thickness of the wafer W. Owing to this, the press force imparted to the upper surface of the outer table 51 is equal to the press force imparted to the wafer W, and thus insufficient sticking pressure or excessive press force is not imparted to the adhesive sheet S. Note that when sticking, for example, an adhesive sheet thicker than the adhesive sheet S shown in FIG. 3, lowering the outer table 51 by an amount equal to the thickness of the sheet can lower the inner table 52 simultaneously. Owing to this, as far as wafers W with identical thickness are concerned, only the level adjustment of the upper surface of the outer table is sufficient. Note that when the thickness of the wafer W is changed, the level of the inner table 52 is adjusted according to the thickness thereof, thus the upper surface of the wafer is adjusted so as to be even with the upper surface of the outer table 51.

In a state that the wafer W is set on the sheet sticking table 13 by means of a transfer arm (not shown), the sticking operation starts. Before sticking operation starts, the brake shoes 32, 42 are brought into contact with the guide rollers 27, 29 to restrain the adhesive sheet S from being fed out. In a state that the sheet sticking table 13 is at a standstill, the press roller 14 rotates and moves on the wafer W leftward in FIG. 4. When the press roller moves, a tension is applied to the adhesive sheet S, and the tension measuring roller 40 is pulled in the X-direction. Then, the load cell 39 measures the tension, and thereby the feed-out head 49 is lowered at an angle by using the sticking-angle maintaining means 37 to maintain a predetermined tension. That is, the load cell 39 measures the tension, and is controlled to output an instruction to the pair of uniaxial robots 46 to maintain the predetermined tension based on the data.

Therefore, as a result, the feed-out head 49 gradually descends along the inclined angle of the guides 45 and uniaxial robots 46 (refer to FIG. 1). Owing to this, even when the length of the adhesive sheet S between the front end of the peel plate 22 and the press roller 14 becomes shorter, the sticking angle θ is maintained constantly to a constant angle.

In this embodiment, as described above, during the sticking operation of the press roller 14, the feed-out head 49 is lowered while the tension of the adhesive sheet S being measured with the load cell 39. As a result, the sticking angle θ is maintained. However, control of descent of the feed-out head 49 may eliminate the load cell 39. That is, as shown in FIG. 4(A), assuming that the lowermost position of the press roller 14 and the front edge position of the peel plate 22 at the start point of the sticking operation be P1 and P2 respectively; the front edge position of the peel plate 22 at the point when the sticking operation of the adhesive sheet S has been completed be P3; and the sticking angle formed by P2, P1 and P3 be θ, the following arrangement may also be adopted. That is, the uniaxial robots 46 and are controlled synchronously to lower the feed-out head constituting the sticking-angle maintaining means 37 along the guide bars 45 so that, as the press roller 14 moves and the distance between the points P1 and P3 is made smaller by the uniaxial robot 60, the level of the peel plate 22, that is the distance between the points P2 and P3 also becomes shorter, and thus the sticking angle θ is constantly maintained. Note that the movement amount of the feed-out head 49 is readily calculated by using the trigonometric function. Thus, by constantly maintaining the sticking angle θ based on the detection of the movement distance of the press roller 14, the same operation and effect as those of the tension control using the load cell 39 can be obtained. In the present invention, these control methods can be employed selectively.

As shown in FIGS. 4(D) and 4(E), when the sticking operation of the adhesive sheet S has been completed, the cutter 15 descends to cut the adhesive sheet S along the peripheral edge of the wafer W, and then the cutter 15 goes up to return to the initial position (refer to FIG. 1). At this time, the front end of the peel plate 22 is positioned in the vicinity of the left end of the wafer W. Owing to this, the area of the adhesive sheet existing at the left side from the front edge position of the peel plate 22 can be used as the area to be stuck to the next wafer W, thus the adhesive sheet S is prevented from being consumed wastefully.

Then, after the wafer W is removed from the sheet sticking table 13 by means of a transfer apparatus, as shown in FIGS. 5(A) to 5(D), the press roller 14 goes up, and the small diameter roller 70 and the large diameter roller 71 constituting the peeling apparatus 16 move leftward. And the drive roller 80 of the winding apparatus 17 is driven to wind the unnecessary adhesive sheet S1; thus the unnecessary adhesive sheet S1 around the wafer W can be peeled off from the upper surface of the sheet sticking table 13.

Then, the brake shoes 32, 42 move away from the guide rollers 27, 29 so that the raw strip sheet L can be fed out, and in a state that the drive roller 80 is locked, the peeling apparatus 16 and the winding apparatus 17 return to the initial position. As a result, new adhesive sheet S is pulled out and new wafer W is transferred onto the sheet sticking table 13 again.

Therefore, according to the embodiment as described above, the level of the upper surface of the outer table 51 can be adjusted according to the thickness of the adhesive sheet S to optimize the sticking pressure. On the other hand, when the thickness of the wafer W is changed, the level of the inner table 52 can be adjusted independently. Owing to this, such advantage that the adhesive sheet S can be precisely stuck with an optimum press force through the press roller 14.

The best arrangement, method and the like for carrying out the present invention have been disclosed so far. However, the present invention is not limited to the above.

That is, the present invention has been illustrated and described mainly about a specific embodiment. However, it is possible for ones skilled in the art to add various modifications, if necessary, to the above-described embodiment with respect to the shape, position and/or disposition without departing from the technical spirit and the range of the object of the present invention.

For example, in the-above described embodiment, an example of arrangement in which the plate-like object is a wafer has been described. However, the present invention is applicable to such arrangement that sheet and film are stuck to a plate-like object other than the wafer.

Also, the sheet sticking table 13 may employ such arrangement rotatable within a plane. In this case, the adhesive sheet S can be cut without rotating the cutter 15.

1. A sheet sticking table for sticking a sheet onto an upper surface of a plate-like object through pressing by a press roller, the sheet being fed out from a sheet feed-out unit, comprising:
an inner table for supporting said plate-like object; and
an outer table disposed to surround the inner table, wherein
said inner table moves in the vertical direction corresponding to the thickness of said plate-like object with the upper surface of said outer table as a reference position,
said press roller is provided movably in the vertical direction corresponding to the thickness of said sheet with the upper surface of said outer table as a reference.

2. A sheet sticking table for sticking a sheet onto an upper surface of a plate-like object through pressing by a press roller, the sheet being fed out from a sheet feed-out unit, comprising:
an inner table for supporting said plate-like object; and
an outer table disposed to surround the inner table, wherein
said outer table moves in the vertical direction corresponding to the thickness of said plate-like object with the upper surface of said inner table as a reference position,
said press roller is provided movably in the vertical direction corresponding to the thickness of said sheet with the upper surface of said outer table as a reference.

3. A sheet sticking table for sticking a sheet onto an upper surface of a plate-like object through pressing by a press roller, the sheet being fed out from a sheet feed-out unit, comprising:
an inner table for supporting said plate-like object; and
an outer table disposed to surround the inner table, wherein
said inner table and outer table are provided movably in the vertical direction respectively.

4. The sheet sticking table according to claim 3, wherein said inner table is provided movably in the vertical direction together with the outer table when the outer table is moved in the vertical direction.

5. The sheet sticking table according to claim 3, wherein said inner table moves in the vertical direction corresponding to the thickness of said plate-like object with the upper surface of said outer table as a reference position, said outer table moves in the vertical direction corresponding to the thickness of said sheet with the press surface of said press roller as a reference, whereby the press force of said press roller is maintained at a constant level.

6. The sheet sticking table according to any one of claims 1 to 5, wherein a gap for cutting the sheet stuck on the plate-like object along the outer edge of the plate-like object is formed between said inner table and said outer table.

7. The sheet sticking table according to any one of claims 1 to 5, wherein the plane shape of said inner table is substantially identical to the plane shape of the plate-like object.
